(19) United States
(12) Patent Application Publication
(10) Pub. No.: US 2025/0105969 A1
(43) Pub. Date: Mar. 27, 2025

(54) ENCODING SYSTEM AND METHOD BASED ON POSITIONING RESOURCE SEQUENCE SUPPORTING CONTINUOUS HYBRID POSITIONING

(71) Applicant: ELECTRONICS AND TELECOMMUNICATIONS RESEARCH INSTITUTE, Daejeon (KR)

(72) Inventors: Jaejun Yoo, Daejeon (KR); Min Jung Kim, Daejeon (KR)

(21) Appl. No.: 18/826,729

(22) Filed: Sep. 6, 2024

(30) Foreign Application Priority Data
Sep. 22, 2023 (KR) 10-2023-0126730

(51) Int. Cl. H04L 5/00; G01S 19/48; H04W 64/00

(52) U.S. Cl. CPC H04L 5/005; G01S 19/48; H04W 64/003

(57) ABSTRACT

Disclosed are a system and method for encoding, in the form of a sequence, various types of positioning resources that are collected in order to support various types of positioning in a GNSS shadow area. An encoding system based on a positioning resource sequence that supports continuous hybrid positioning includes an input interface device configured to collect positioning resources in a positioning target space, memory in which a program that performs encoding on the positioning resources has been stored, and a processor configured to execute the program. The processor allocates an index to the positioning resource by considering the type of each positioning resource and encodes the positioning resource in the form of a sequence.

### CROSS-REFERENCE TO RELATED APPLICATION(S)

This application claims priority to and the benefit under 35 USC § 119 of Korean Patent Application No. 10-2023-0126730 filed on Sep. 22, 2023 in the Korean Intellectual Property Office, the entire disclosures of which is incorporated herein by reference for all purposes.

### BACKGROUND

### 1. Technical Field

The present disclosure relates to a system and method for encoding, in the form of a sequence, various types of positioning resources that are collected in order to support various types of positioning in a GNSS shadow area.

### 2. Description of Related Art

A demand for determining the location of a mobile terminal indoors is expanded. Hybrid positioning is defined as a positioning technology in which various positioning resources and methods are complexly used. A scheme for performing positioning by using various radio signals and sensors is used as the positioning technology.

A conventional technology in which positioning resources are imaged has a problem in that efficient indication for positioning resources that are collected in a GNSS shadow area is not performed.

### SUMMARY

Various embodiments are directed to providing a system and method capable of supporting continuous hybrid positioning in a GNSS shadow area (or an interior) by encoding positioning resources that are collected in a target space in the form of a sequence.

An encoding system based on a positioning resource sequence that supports continuous hybrid positioning according to an embodiment of the present disclosure includes an input interface device configured to collect positioning resources in a positioning target space, memory in which a program that performs encoding on the positioning resources has been stored, and a processor configured to execute the program. The processor allocates an index to the positioning resource by considering the type of each positioning resource and encodes the positioning resource in the form of a sequence.

The processor performs the encoding in the form of the sequence including a string or numbers.

The processor performs the encoding by specifying a measured value and descriptive data of a corresponding positioning resource at a location at which the index is designated.

The processor maps an equipment identifier by applying a hash value of an algorithm to an attribute information value of the positioning resource.

The processor maps an equipment identifier based on an index value of an array in which attribute information values of the positioning resources are stored and managed.

The processor includes an expressive phrase “empty” with respect to an unallocated area within the sequence.

The processor allocates a preset special value to an unallocated area within the sequence.

The processor uses a certain value as a value that expresses the unallocated area by considering a range of values that are expressed in an area within the sequence and converts and expresses an attribute information value of the positioning resource by considering the range.

The processor determines the location of a terminal in the positioning target space by performing similarity search on a set of the sequences.

An encoding method based on a positioning resource sequence that supports continuous hybrid positioning according to an embodiment of the present disclosure includes steps of (a) collecting positioning resources in a positioning target space and (b) performing encoding on the positioning resource in the form of a sequence by considering the type of each positioning resource.

In the step (a), the positioning resources including a wireless communication signal and a sensing signal that are used for the positioning of a mobile terminal are collected.

In the step (b), the encoding is performed by specifying at least any one of a measured value and descriptive data of a corresponding positioning resource by considering an index that is allocated depending on the type of each positioning resource.

In the step (b), the encoding is performed on the positioning resource in the form of the sequence including a string or numbers.

In the step (b), the encoding is performed by including a phrase that expresses information on an area that is not allocated to any positioning resource within the sequence.

In the step (b), a specific value is expressed as the phrase.

In the step (b), an attribute information value of the positioning resource other than an area in which the specific value is allocated is converted and expressed by considering a range of values that are expressed in the sequence.

An encoding system based on a positioning resource sequence that supports continuous hybrid positioning according to an embodiment of the present disclosure includes a terminal configured to collect positioning resources and transmit the positioning resources to a server, and the server configured to perform encoding on the positioning resources received from the terminal, according to a preset rule, and to transmit positioning information based on the encoding to the terminal.

The server performs the encoding in the form of a sequence including a string or numbers, based on an index that is allocated by considering a type of positioning resource, and performs the encoding by specifying a measured value or descriptive data of a corresponding positioning resource at a location at which the index is designated.

An encoding system based on a positioning resource sequence that supports continuous hybrid positioning according to an embodiment of the present disclosure includes a server configured to set a preset encoding rule for positioning resources, and a terminal configured to receive the encoding rule, perform encoding on a collected positioning resource according to the encoding rule, and perform positioning.

The terminal performs the encoding on the collected positioning resource so that a measured value or descriptive data of the collected positioning resource is specified at a location at which an index has been designated, according to the encoding rule depending on a type of positioning resource, and performs the positioning by performing similarity search based on results of the encoding.

The embodiments of the present disclosure have effects in that information can be efficiently expressed, various similarity search technologies can be applied, positioning resources can be shared and used, and various types of positioning can be performed based on the sharing and use of positioning resources, by sequencing obtained positioning resources.

Effects of the present disclosure are not limited to the aforementioned effects, and other effects not described above may be evidently understood by those skilled in the art from the following description.

### BRIEF DESCRIPTION OF THE DRAWINGS

FIG. 1 illustrates a GNSS shadow area (or an interior).

FIG. 2 illustrates positioning resources that are collected in the GNSS shadow area (or an interior) of FIG. 1.

FIG. 3 illustrates the allocation of an identifier for each positioning resource illustrated in FIG. 2.

FIGS. 4 and 5 illustrate examples in which contents illustrated in FIG. 3 are sequenced and expressed.

FIG. 6 illustrates the sequencing of positioning resources according to an embodiment of the present disclosure.

FIG. 7 illustrates an encoding method based on a positioning resource sequence that supports continuous hybrid positioning according to an embodiment of the present disclosure.

FIG. 8 illustrates an encoding system based on a positioning resource sequence that supports continuous hybrid positioning according to an embodiment of the present disclosure.

FIG. 9 is a block diagram illustrating a computer system for implementing the encoding method according to an embodiment of the present disclosure.

### DETAILED DESCRIPTION

The aforementioned object, other objects, advantages, and characteristics of the present disclosure and a method for achieving the aforementioned object, other objects, advantages, and characteristics will become apparent from embodiments described in detail later in conjunction with the accompanying drawings.

However, the present disclosure is not limited to embodiments disclosed hereinafter, but may be implemented in various different forms. The following embodiments are merely provided to easily notify a person having ordinary knowledge in the art to which the present disclosure pertains of the objects, constructions, and effects of the present disclosure. The scope of rights of the present disclosure is defined by the writing of the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other components, steps, operations and/or components in addition to mentioned components, steps, operations and/or components.

As various pieces of equipment such as smartphones and tablets are popularly used, the size of an indoor space is increased, and many activities are done indoors, demands for determining the locations of indoor mobile terminals are expanded. Unlike in an outdoor area to which a GNSS technology in which satellite-based positioning is performed is applied, in order to determine the location of a mobile terminal in a GNSS shadow area or an indoor space, various methods using a radio signal, such as WiFi or BLE, or using a geomagnetic sensor, a barometer, or a lightmeter have been proposed.

A fingerprint scheme is used as a representative method of performing positioning by using various radio signals and sensors. The fingerprint scheme is a method of determining the location of a mobile terminal the location of which is to be determined, which has the closest value, by previously constructing various types of information of a geomagnetic sensor, a barometer, and a lightmeter along with radio signals, such as WiFi and BLE, which are collected at a specific location of a target indoor space in which the location of the mobile terminal is to be determined, comparing corresponding information that is scanned by the mobile terminal in the target indoor space with the previously constructed information, and performing search (similarity search).

In a positioning technology in a GNSS shadow area, information of positioning resources which may be used in a positioning process in a target indoor space needs to be previously constructed. For efficient positioning, such information needs to be efficiently constructed, shared, and used. Accordingly, it is necessary to efficiently construct and encode various resources (e.g., positioning resources), such as signals (e.g., radio signals or sensing signals of a geomagnetic sensor, a barometer, and an altimeter) which will be used for the positioning of a mobile terminal at a specific location of a GNSS shadow area.

Some technologies in which positioning resources are imaged have been proposed. In general, such technologies have a problem in that positioning resources that are collected in a target GNSS shadow area are not efficiently encoded. The application of a wider similarity search method to the technologies is limited because a similarity search method for a given positioning resource is limited to an image-based method.

An embodiment of the present disclosure has been proposed to solve the aforementioned problems, and proposes a system and method for encoding positioning resources at a specific point of a GNSS shadow area (or an interior) in the form of a sequence including a string or numbers. According to an embodiment of the present disclosure, it is possible to apply more various similarity search methods, such as a comparison between strings or a comparison between DNAs and to share positioning resources more efficiently.

An embodiment of the present disclosure proposes a sequence-based positioning resource encoding system and method for supporting continuous hybrid positioning in a GNSS shadow area. An index is allocated to a positioning resource for each type. A measured value of a resource corresponding to a location that is described by a corresponding index and descriptive data of the measured value are specified. If a gap is present between the values of indices allocated to a specific positioning resource, the allocation of an index value can be performed more systematically by indicating the gap in a separate form.

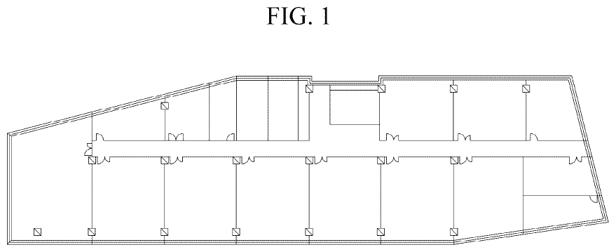

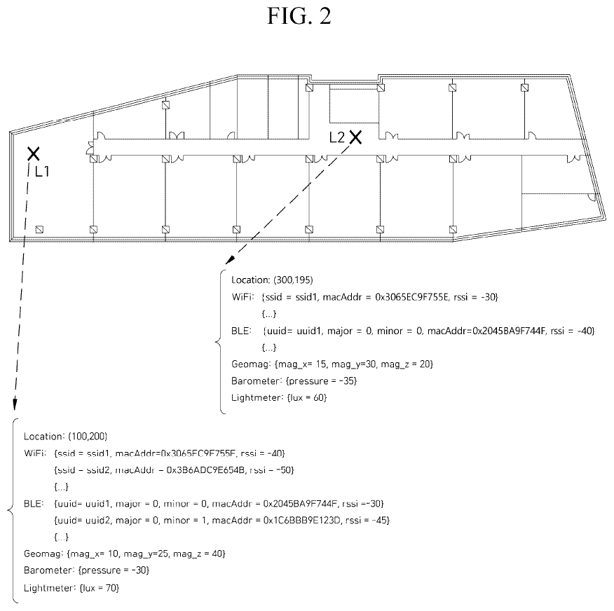

FIG. 1 illustrates a GNSS shadow area (or an interior). FIG. 2 illustrates positioning resources that are collected in the GNSS shadow area (or an interior) of FIG. 1.

FIG. 1 illustrates an example of positioning resources which may be obtained in a GNSS shadow area (or an interior). The example of FIG. 1 may be expanded to new types of additional positioning resources which may be used by various positioning methods. FIG. 2 illustrates positioning resources collected in order to support continuous hybrid positioning at some points L1 and L2 within a corresponding GNSS shadow area. The positioning resources representatively include the values of GNSS, WiFi, BLE, LTE, 5G, a geomagnetic sensor, a barometer, and a lightmeter. Collected information of positioning resources and descriptions thereof are listed in Table 1 in which major components of positioning resources are described.

TABLE 1

| POSITIONING RESOURCE | | |
|---|---|---|
| | ATTRIBUTE | |
| TYPE | INFORMATION | DESCRIPTION |
| WiFi | ssid | SSID value of WiFi AP |
| | macAddr | mac address value of WiFi AP |
| | rssi | RSSI or WiFi AP |
| BLE | uuid | UUID of collected BLE device |
| | macAddr | MAC address of collected BLE device |
| | major | major number of collected BLE device |
| | minor | minor number of collected BLE device |
| | rssi | Intensity of collected BLE signal |
| Geomag | mag_x | x axis value (uT) of geomagnetic sensor |
| | mag_y | y axis value (uT) of geomagnetic sensor |
| | mag_z | z axis value (uT) of geomagnetic sensor |
| Barometer | pressure | Pressure value (hPa) of collected |
| | | barometer |
| Lightmeter | lux | Collected illumination value |

FIG. 2 illustrates an example in which pieces of representative important information, among the information listed in Table 1, are collected at some points within a corresponding GNSS shadow area. For example, a WiFi AP having “ssid1” and “ssid2” as “ssid” is scanned at a point L1. The values “rssi” of the “ssid1” and “ssid2” are −40 and −50, respectively. Furthermore, at the point L1, BLE devices having “uuid1” and “uuid2” as “uuid” are scanned. When compared to the point L1, at a point L2, the same WiFi and BLE equipment have different values “rssi”.

Table 2 lists the mapping of identifiers for each positioning resource. In Table 2, information of a positioning resource for each type in Table 1 has been substituted with an identification information value “id” for corresponding equipment. For example, a WiFi AP may be identified based on “ssid” and “macAddr”. The “ssid” and “macAddr” are mapped to one identifier “id”. Various methods may be applied to the mapping. As a method of mapping an equipment identifier, a hash value of a specific algorithm may be applied to the value “macAddr” in the case of WiFi, or the use of an index value of a kind of array in which all of address values “macAddr” are stored and managed may be applied.

The range in which the identifier “id” is allocated to a positioning device is mapped depending on the type of positioning resource. For example, 0 is allocated to the identifier value of a geomagnetic sensor, 3 is allocated to the identifier value of a barometer, and 4 is allocated to the identifier value of a lightmeter. Multiple WiFi APs may be scanned at one point. Accordingly, preset values (e.g., from 5 to 79) are allocated to the identifier values of the WiFi APs based on information “ssid” or “macAddr”. The identifier value of a BLE AP is allocated with reference to a preset value (e.g., in a range that is subsequent to 80).

According to an embodiment of the present disclosure, identifier information for each positioning resource is used as a location value by which the value of a corresponding positioning resource is specified when corresponding information is converted in the form of a sequence. Various schemes may be applied to a mapping scheme that is applied for the mapping of an identifier value for each positioning resource, depending on their purposes, designs, and implementation situations. An important part in the mapping of the identifier value is that the identifier value has to be mapped so that the same positioning resource device has the same identifier. It is necessary to set what range of values mapped identifier values have depending on the type. The mapped identifier values do not need to be essentially continuous.

TABLE 2

| POSITIONING RESOURCE | | |
|---|---|---|
| | ATTRIBUTE | |
| TYPE | INFORMATION | DESCRIPTION |
| WiFi | id | Identification information (calculated |
| | | based on ssid, macAddr information) of |
| | rssi | WiFi AP RSSI or WiFi AP |
| BLE | id | Identification information (calculated |
| | | based on uuid, macAddr, major, and |
| | | minor information) of BLE AP |
| | rssi | Intensity of collected BLE signal |
| Geomag | id | Geomagnetic sensor value, an identifier |
| | | value is fixed to 0. |
| | mag_x | x axis value (uT) of geomagnetic sensor |
| | mag_y | y axis value (uT) of geomagnetic sensor |
| | mag_z | z axis value (uT) of geomagnetic sensor |
| Barometer | id | Collected barometer value, an identifier |
| | | value is fixed to 3. |
| | pressure | Collected pressure value (hPa) of |
| | | barometer |
| Lightmeter | id | Collected illumination value, an |
| | | identifier value is fixed to 4. |
| | lux | Collected illumination value |

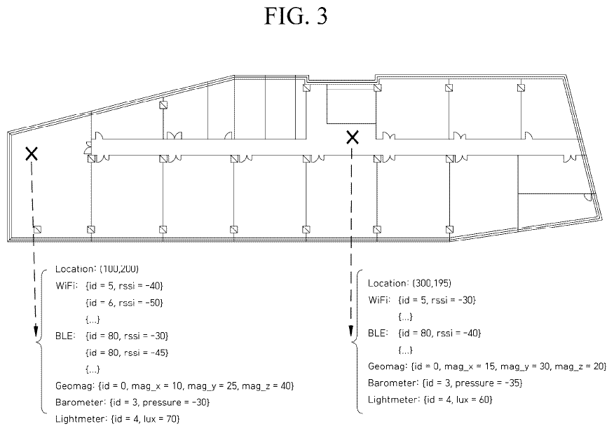

FIG. 3 illustrates the allocation of an identifier for each positioning resource illustrated in FIG. 2.

FIG. 3 illustrates an example in which parts which may be used to identify devices or positioning resources, among the values of the positioning resources illustrated in FIG. 2, have been substituted with the identifiers “id” by incorporating the contents of Table 2.

Collected information is encoded in the form of a sequence according to the following process. Information of the identifier “id” that is allocated to each positioning resource is used as the index number of an array in which corresponding information is stored. In a sequence in which positioning resources are encoded, the value of a radio signal for a positioning resource is stored at a location that is indicated by a corresponding index value.

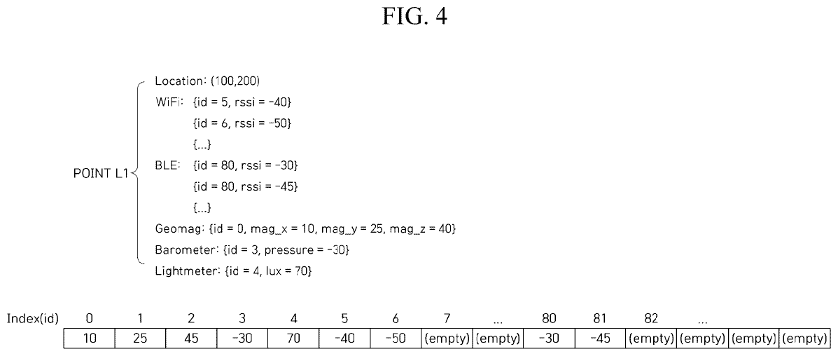

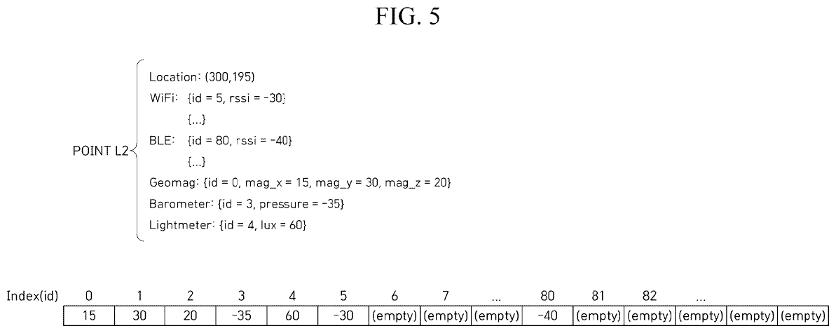

FIGS. 4 and 5 illustrate examples in which the contents illustrated in FIG. 3 are sequenced and expressed. FIG. 4 illustrates an example in which information of the positioning resources at the point L1 has been sequenced. FIG. 5 illustrates an example in which information of the positioning resources at the point L2 has been sequenced.

An expression of “empty” for an unallocated location is included in FIGS. 4 and 5.

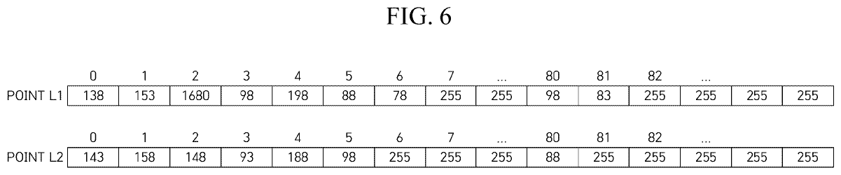

In order to digitize a part that does not correspond to an identifier allocated to a positioning resource, the part may be used by allocating one special value that means the part. In this case, a numerical value that means “empty” should not be used as a meaningful value within a sequence. The numerical value that means “empty” may be adjusted through pre-processing. For example, if the range of element values at each location of a sequence is 0 to 255, values corresponding to all of the locations of the sequence may be digitized by using 255 as a value that means “empty” and allocating the range of—values to 0 to 127, 0 to 128, and the range of +values to 129 to 254. FIG. 6 illustrates the results of the sequencing of positioning resources for the contents of FIG. 5 according to another embodiment of the present disclosure. As illustrated in FIG. 6, information of the positioning resources has been encoded in the form of the sequence so that information obtained at each point can be efficiently expressed. If a fingerprint is constructed based on the encoded information, various sequence-based similarity search methods may be applied for similarity search. According to an embodiment of the present disclosure, similarity search attempts having wider and various purposes may be made on constructed positioning resources.

According to an embodiment of the present disclosure, information of positioning resources that are collected is sequenced and expressed. Sequence data may be considered like DNA from the viewpoint of a positioning resource, which is called IndoorDNA. In the embodiment of the present disclosure, WiFi, BLE, a geomagnetic sensor, a barometer, and a lightmeter have been described, but the present disclosure may also be expanded and applied to various positioning resources, such as UWB and LTE/5G.

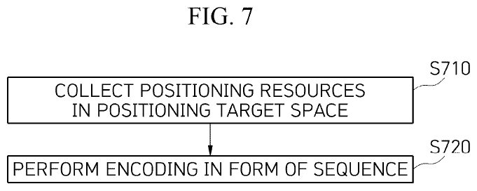

FIG. 7 illustrates an encoding method based on a positioning resource sequence that supports continuous hybrid positioning according to an embodiment of the present disclosure.

The encoding method based on a positioning resource sequence that supports continuous hybrid positioning according to an embodiment of the present disclosure includes step S710 of collecting positioning resources in a positioning target space and step S720 of performing encoding on positioning resources in the form of a sequence by considering the type of each positioning resource.

In step S710, positioning resources, including wireless communication signals and sensing signals that are used for the positioning of a mobile terminal, are collected.

In step S720, at least any one of the measured value and descriptive data of a corresponding positioning resource is specified and encoding is performed on the positioning resource, by considering an index that is allocated depending on the type of each positioning resource.

In step S720, encoding is performed on the positioning resources in the form of a sequence including a string or numbers.

In step S720, the encoding is performed by including a phrase that expresses information on an area that has not been allocated to any positioning resource within the sequence.

In step S720, a specific value is expressed as the phrase.

In step S720, an attribute information value of a positioning resource other than an area in which the specific value is allocated is converted and expressed by considering the range of values that are expressed in the form of the sequence.

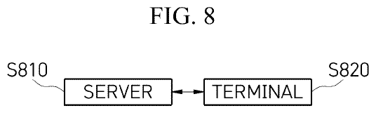

FIG. 8 illustrates an encoding system based on a positioning resource sequence that supports continuous hybrid positioning according to an embodiment of the present disclosure.

The encoding system based on a positioning resource sequence that supports continuous hybrid positioning according to an embodiment of the present disclosure includes a terminal 820 that collects a positioning resource and transmits the positioning resource to a server 810, and the server 810 that performs encoding on the positioning resource received from the terminal according to a preset rule and that transmits positioning information based on the encoding to the terminal 820.

The server 810 performs encoding in the form of a sequence including a string or numbers, based on an index that is allocated by considering the type of positioning resource, and performs the encoding by specifying a measured value or descriptive data of the positioning resource at a location at which the index is designated.

The encoding system based on a positioning resource sequence that supports continuous hybrid positioning according to another embodiment of the present disclosure includes the server 810 that sets an encoding rule for a positioning resource and the terminal 820 that receives the encoding rule, performs encoding on positioning resources that are collected according to the encoding rule, and performs positioning.

The terminal 820 performs encoding on a collected positioning resource so that a measured value or descriptive data of the collected positioning resource is specified at a location at which an index has been designated, according to a preset encoding rule depending on the type of positioning resource, and performs positioning by performing similarity search based on the results of the encoding.

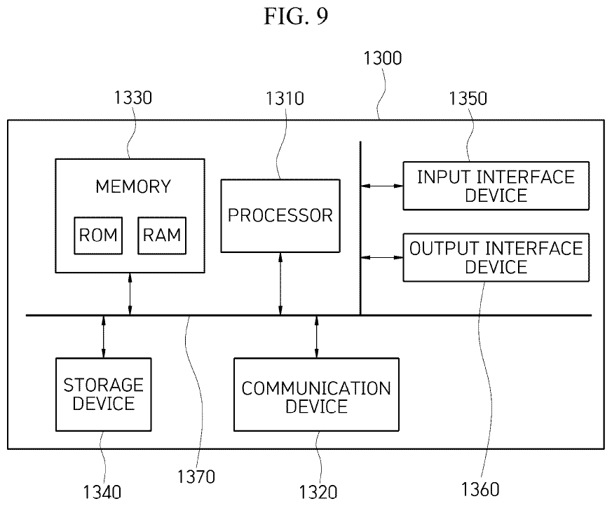

FIG. 9 is a block diagram illustrating a computer system for implementing the encoding method according to an embodiment of the present disclosure.

Referring to FIG. 9, a computer system 1300 may include at least one of a processor 1310, memory 1330, an input interface device 1350, an output interface device 1360, and a storage device 1340 which communicate with each other through a bus 1370. The computer system 1300 may further include a communication device 1320 connected to a network. The processor 1310 may be a central processing unit (CPU) or may be a semiconductor device that executes instructions stored in the memory 1330 or the storage device 1340. The memory 1330 and the storage device 1340 may include various types of volatile or nonvolatile storage media. For example, the memory may include read only memory (ROM) and random access memory (RAM). In an embodiment of the present specification, the memory may be disposed inside or outside the processor, and may be connected to the processor through various known means. The memory includes various types of volatile or nonvolatile storage media, and may include read-only memory (ROM) or random access memory (RAM), for example.

The encoding system based on a positioning resource sequence that supports continuous hybrid positioning according to an embodiment of the present disclosure includes the input interface device 1350 that collects positioning resources at a positioning target space, the memory 1330 in which a program that performs encoding on positioning resources has been stored, and the processor 1310 that executes the program. The processor 1310 allocates an index to a positioning resource by considering the type of each positioning resource and encodes the positioning resources in the form of a sequence.

The processor 1310 performs the encoding in the form of the sequence including a string or numbers.

The processor 1310 performs the encoding by specifying a measured value and descriptive data of a corresponding positioning resource at a location at which the index is designated.

The processor 1310 maps an equipment identifier by applying a hash value of an algorithm to an attribute information value of the positioning resource.

The processor 1310 maps the equipment identifier based on an index value of an array in which the attribute information values of the positioning resources are stored and managed.

The processor 1310 includes an expressive phrase “empty” with respect to an unallocated area within the sequence.

The processor 1310 allocates a preset special value to the unallocated area within the sequence.

The processor 1310 uses a certain value as the value that expresses the unallocated area by considering the range of values that are expressed in an area within the sequence, and converts and expresses an attribute information value of a positioning resource by considering the range.

The processor 1310 determines the location of the terminal in a positioning target space by performing similarity search on a set of the sequences.

Accordingly, an embodiment of the present disclosure may be implemented as a method implemented in a computer or may be implemented as a non-transitory computer-readable medium in which a computer-executable instruction has been stored. In an embodiment, when being executed by a processor, a computer-readable instruction may perform a method according to at least one aspect of this writing.

The communication device 1320 may transmit or receive a wired signal or a wireless signal.

Furthermore, the method according to an embodiment of the present disclosure may be implemented in the form of a program instruction which may be executed through various computer means, and may be recorded on a computer-readable medium.

The computer-readable medium may include a program instruction, a data file, and a data structure alone or in combination. A program instruction recorded on the computer-readable medium may be specially designed and constructed for an embodiment of the present disclosure or may be known and available to those skilled in the computer software field. The computer-readable medium may include a hardware device configured to store and execute the program instruction. For example, the computer-readable medium may include magnetic media such as a hard disk, a floppy disk, and a magnetic tape, optical media such as CD-ROM and a DVD, magneto-optical media such as a floptical disk, ROM, RAM, and flash memory. The program instruction may include not only a machine code produced by a compiler, but a high-level language code capable of being executed by a computer through an interpreter.

The embodiments of the present disclosure have been described in detail, but the scope of rights of the present disclosure is not limited thereto. A variety of modifications and changes of those skilled in the art using the basic concept of the present disclosure defined in the appended claims are also included in the scope of rights of the present disclosure.

What is claimed is:

1. An encoding system based on a positioning resource sequence that supports continuous hybrid positioning, the encoding system comprising:
an input interface device configured to collect positioning resources in a positioning target space;
memory in which a program that performs encoding on the positioning resources has been stored; and
a processor configured to execute the program,
wherein the processor allocates an index to the positioning resource by considering a type of each positioning resource and encodes the positioning resource in a form of a sequence.

2. The encoding system of claim 1, wherein the processor performs the encoding in the form of the sequence including a string or numbers.

3. The encoding system of claim 1, wherein the processor performs the encoding by specifying a measured value and descriptive data of a corresponding positioning resource at a location at which the index is designated.

4. The encoding system of claim 1, wherein the processor maps an equipment identifier by applying a hash value of an algorithm to an attribute information value of the positioning resource.

5. The encoding system of claim 1, wherein the processor maps an equipment identifier based on an index value of an array in which attribute information values of the positioning resources are stored and managed.

6. The encoding system of claim 1, wherein the processor includes an expressive phrase “empty” with respect to an unallocated area within the sequence.

7. The encoding system of claim 1, wherein the processor allocates a preset special value to an unallocated area within the sequence.

8. The encoding system of claim 7, wherein the processor uses a certain value as a value that expresses the unallocated area by considering a range of values that are expressed in an area within the sequence and converts and expresses an attribute information value of the positioning resource by considering the range.

9. The encoding system of claim 1, wherein the processor determines a location of a terminal in the positioning target space by performing similarity search on a set of the sequences.

10. An encoding method based on a positioning resource sequence that supports continuous hybrid positioning, the encoding method comprising steps of:
(a) collecting positioning resources in a positioning target space; and
(b) performing encoding on the positioning resource in a form of a sequence by considering a type of each positioning resource.

11. The encoding method of claim 10, wherein in the step (a), the positioning resources comprising a wireless communication signal and a sensing signal that are used for a positioning of a mobile terminal are collected.

12. The encoding method of claim 10, wherein in the step (b), the encoding is performed by specifying at least any one of a measured value and descriptive data of a corresponding positioning resource by considering an index that is allocated depending on the type of each positioning resource.

13. The encoding method of claim 10, wherein in the step (b), the encoding is performed on the positioning resource in the form of the sequence comprising a string or numbers.

14. The encoding method of claim 10, wherein in the step (b), the encoding is performed by including a phrase that expresses information on an area that is not allocated to any positioning resource within the sequence.

15. The encoding method of claim 14, wherein in the step (b), a specific value is expressed as the phrase.

16. The encoding method of claim 15, wherein in the step (b), an attribute information value of the positioning resource other than an area in which the specific value is allocated is converted and expressed by considering a range of values that are expressed in the sequence.

17. An encoding system based on a positioning resource sequence that supports continuous hybrid positioning, the encoding system comprising:
a terminal configured to collect positioning resources and transmit the positioning resources to a server; and
the server configured to perform encoding on the positioning resources received from the terminal, according to a preset rule, and to transmit positioning information based on the encoding to the terminal.

18. The encoding system of claim 17, wherein the server performs the encoding in a form of a sequence comprising a string or numbers, based on an index that is allocated by considering a type of positioning resource, and performs the encoding by specifying a measured value or descriptive data of a corresponding positioning resource at a location at which the index is designated.

19. An encoding system based on a positioning resource sequence that supports continuous hybrid positioning, the encoding system comprising:
a server configured to set a preset encoding rule for positioning resources; and
a terminal configured to receive the encoding rule, perform encoding on a collected positioning resource according to the encoding rule, and perform positioning.

20. The encoding system of claim 19, wherein the terminal performs the encoding on the collected positioning resource so that a measured value or descriptive data of the collected positioning resource is specified at a location at which an index has been designated, according to the encoding rule depending on a type of positioning resource, and performs the positioning by performing similarity search based on results of the encoding.
